(19) United States
(12) Patent Application Publication
(10) Pub. No.: US 2007/0158487 A1
(43) Pub. Date: Jul. 12, 2007

(54) Belt winder

(75) Inventor: Oliver Glinka, Ulm (DE)

Correspondence Address: FOLEY AND LARDNER LLP;SUITE 500, 3000 K STREET NW, WASHINGTON, DC, 20007, US

(73) Assignee: TAKATA-PETRI (Ulm) GmbH

(21) Appl. No.: 11/476,909

(22) Filed: Jun. 29, 2006

(30) Foreign Application Priority Data
Jul. 1, 2005 (DE) 10 2005 032 012.0

(51) Int. Cl. B60R 22/28

(52) U.S. Cl. 242/379.1

(57) ABSTRACT

The disclosed belt winder can comprise a belt spindle for winding a safety belt, a belt force limiting device in communication with the belt spindle for limiting a belt restraining force exerted by the seat belt in case of an accident, and a belt force increasing device for blocking further extraction of the safety belt upon reaching a predetermined belt extraction length. The belt force increasing device can be configured to automatically deactivate itself upon exceeding a preset maximum belt restraining force.

### BACKGROUND

The invention relates to a belt winder (or belt retractor) having features of a belt spindle for winding a safety belt on and off and a belt force limiting device in communication with the belt spindle which, in case of an accident, limits the belt restraining force exerted by the safety belt.

A belt winder of this kind is disclosed in the international patent application WO 97/04996. This belt winder has a torsion bar as the belt force limiting system. In addition, the previously known belt winder has a belt extraction limiting system in the form of a restraining belt which, in case of an accident, limits the belt extraction and the twisting of the torsion bar beyond a given amount as soon as the safety belt is fully wound to the locking base of the belt winder.

In European patent EP 1 149 743 B1, a belt winder is disclosed that has two belt force limiting devices. The one belt force limiting device is formed by a torsion bar which twists in case of an accident and thus limits the restraining force. Another belt force limiting device is formed by a wire which is contained in a spindle of the belt winder. In case of an accident, if the belt spindle rotates relative to the locking base of the belt winder, the wire is drawn out of the belt spindle. Thus, a friction force and a deformation force need to be overcome, which increase the belt restraining power of the belt winder. Therefore, the restraining force is the torque of the torsion bar and the friction and deformation force of the wire. A cutting device is connected with the wire, which can cut through the wire and thus end the action of any friction and deformation force of the wire. In such a case, the resultant restraining force is determined solely by the torsion bar. In all, two different restraining forces can be established by the two belt force limiting devices, namely a larger restraining force which is produced by the torsion bar and the wire, and a smaller restraining force which is determined by the torsion bar alone after the wire has been cut or drawn all the way out of the belt spindle.

The invention of the present application can address the problem of providing a belt winder which can be used more universally than previous belt winders.

This problem can be solved by an embodiment of the present invention in which a belt winder comprises a belt force increasing device.

### SUMMARY

It is provided according to an embodiment of the present invention that a belt force increasing device is present which, when a given belt extraction length is reached, blocks any further extraction of the safety belt. Upon reaching that preset belt extraction length, the belt force increasing device thus interrupts the belt extraction. Any exceeding of a preset maximum belt restraining force can be prevented by automatically and entirely deactivating the belt force increasing device when a preset maximum belt restraining force is reached.

One advantage of the belt winder according to an embodiment of the present invention is to be seen in the fact that it can be used also on rear seats. In many countries—in the USA, for example—a so-called “loop-load” test (a belt loop load test, cf. e.g. US Standard FMVSS209) is prescribed. According to this test, no more than a given belt extraction length is to be possible on the rear seats at a standard belt extraction force. This specified belt extraction force is, however, greater than the belt force level common in belt force limiting devices, such as torsion bars for example, so that a belt winder is unable to pass the “loop-load” test with a torsion bar alone. At this point, an embodiment of the present invention comes in and provides the belt force increasing device which, upon reaching the specified belt extraction length, prevents any further extraction of the safety belt; thus passing the loop-load test. Unlike the belt winder with the belt extraction limiting device according to the international patent application WO 97/04996, the belt winder according to the invention additionally offers greater protection against injury by the safety belt because the belt force increasing device, upon exceeding the given maximum belt restraining force, becomes automatically and completely deactivated. Thus, unnecessary injuries are avoided.

Preferably, before the preset belt extraction length is reached, the belt force increasing device leaves the belt extraction unaffected, or at least approximately unaffected, so that the preset belt force limiting action is determined alone or mainly by the belt force limiting device.

The construction of the belt winder is especially economical and therefore advantageous if the belt force increasing device is configured such that, when the preset maximum belt restraining force is exceeded, it tears or breaks. Preferably, the belt force increasing device has a corresponding break-off point.

According to a preferred embodiment of the belt winder, a provision can be made for the belt force limiting device to be formed by a torsion bar which at its one end is connected with the belt spindle and at its other end to a clutch. When no accident occurs, the belt force limiting device rotates together with the belt spindle, and in the event of an accident, it locks up, especially by means of a clutch such as a locking pawl.

Preferably the belt force increasing device may be formed by a windable element, especially a belt or a cable. For example, the windable element is attached at its one end to the belt spindle and at its other end to the clutch.

According to a preferred embodiment of the belt winder, an arrangement can be made for the windable element to be arranged such that, in case of extraction of the belt while the clutch is engaged, it is wound onto a winding device. The winding device can be formed, for example, by a groove in the belt spindle, by an area for receiving it on the locking device, or by the torsion bar itself.

Preferably, the length of the windable element is such that, after the preset belt extraction length is reached, it is wound entirely onto the winding device and the belt restraining force is increased.

With a view towards an especially compact mounting of the windable element, it can be considered advantageous if the windable element is at least partially wound when the belt winder is in the ready state, i.e., before the occurrence of an accident.

It can be considered to be especially advantageous if, when the belt winder is in the ready state, the windable element is wound on such that, in case of a belt extension with the clutch locked, it is first unwound and after it is fully unwound it is rewound again but in the opposite winding direction. In other words, the windable element is therefore wound on the winding device in the “delivery state” or basic state of the belt winder, contrary to the unwinding direction of the belt winder. The result of this winding direction is that activation of the belt force increasing device does not occur until the windable element has been unwound twice, namely once unwound and then wound on again. Thus a delayed triggering (i.e., a long belt extraction) can be achieved with a relatively short windable element; thus a very short length of the windable element is sufficient.

In order to start the deactivation of the belt force increasing device in an especially simple manner, the windable element can have at least one break-off point which breaks open when the preset maximum belt restraint force is exceeded.

If the belt winder is to withstand the above-mentioned loop-load test of US Standard FMVSS209, the maximum belt restraining force of the belt force increasing device is preferably greater than 6672 N (150 lb.). The preset belt extraction length is then preferably less than 508 mm (20″).

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows a belt winder according to an embodiment of the present invention with a torsion bar as the belt force limiting means and a cord as the belt force increasing device.

FIG. 2 shows a diagram representing the belt restraining force as a function of the belt extraction length.

### DETAILED DESCRIPTION

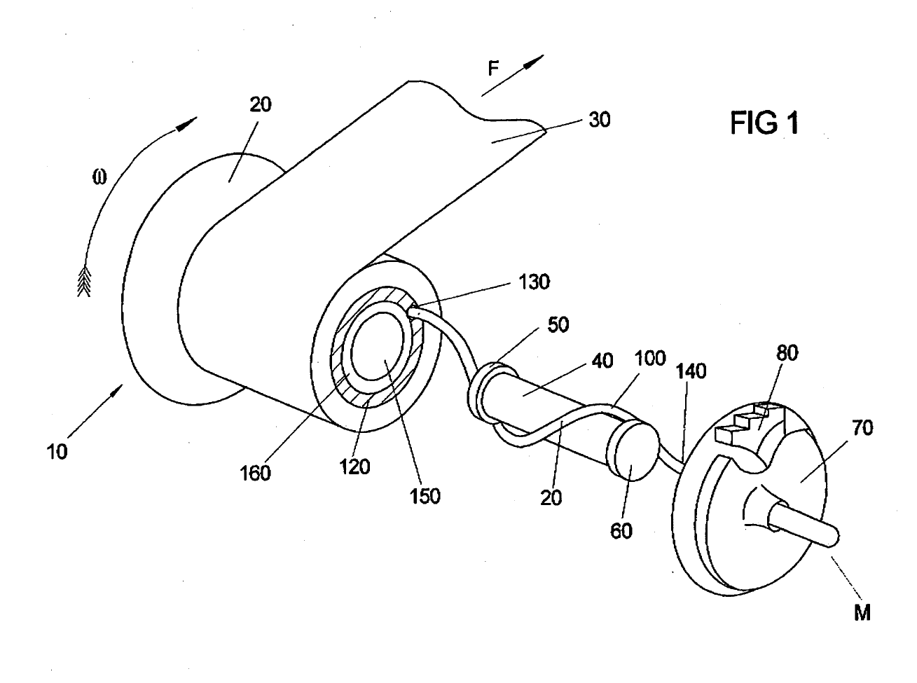

An embodiment of the present invention will now be described with reference to FIG. 1. This figure shows a belt winder 10 with a belt spindle 20 on which a safety belt 30 can be wound and unwound. A belt force limiting device in the form of a torsion bar 40 is in communication with the belt spindle 20. One end 50 of the torsion bar 40 is co-rotationally fastened in a secured fashion to the belt spindle 20.

Another end 60 of the torsion bar 40 is co-rotationally connected with a clutch 70 which, in an accident-free case, rotates with the belt spindle 20 and, in case of an accident, locks up. For this purpose, the clutch 70 is provided with a pawl 80 which swings outwardly in case of an excessively abrupt extraction of the belt or in case of an activation by a sensor (e.g., a belt acceleration sensor, vehicle acceleration sensor, or vehicle tilt sensor). The pawl 80 thus joins the clutch 70 with a winding frame not shown in FIG. 1 and joins it for co-rotation with the vehicle structure so that the clutch 70 is engaged and can no longer continue to rotate.

As can be seen in FIG. 1, a cable 100 is wound in an annular receiving channel 120—wound, that is, contrary to the belt winding direction W of the belt winder 10. The annular channel 120 forms a means for winding the cable 100.

The one extremity 130 of the cable 100 is fastened in the annular channel 120 that is rotationally symmetrical with the axis of rotation M of the belt spindle 20. The other end 140 of the cable 100 is attached to the clutch 70.

The channel 120 is arranged to be concentric with the cylindrical cavity 150 in which the torsion bar 40 lies. The channel 120 and the cylindrical cavity 150 are separated from one another only by a narrow annular separation 160. The torsion bar 40 is also separated by this separation 160 from the cable 100 so that the torsion bar 40 cannot interfere with the winding and unwinding of the cable 100.

The belt winder 10 according to FIG. 1 operates as follows.

In case of a vehicle accident, an abrupt forward movement of a vehicle occupant protected by a safety belt 30 will occur so that coincidentally therewith the safety belt 30 is unwound abruptly from the belt spindle 20. In this case, the pawl 80 will swing outwardly—for example because it is triggered by one of the sensors referred to above—and the clutch 70 will lock with the winding frame. The other end 60 of the torsion bar 40 is now locked so that it can no longer rotate together with the belt spindle 20. On account of the belt extraction force F occurring due to the forward movement of the vehicle occupant, the end 50 of the torsion bar 40 will, however, continue rotating so that the torsion bar 40 is torqued. The safety belt 30 is thus further unwound, while a belt restraining force Fₜ determined by the mechanical torque resistance is applied to the vehicle occupant.

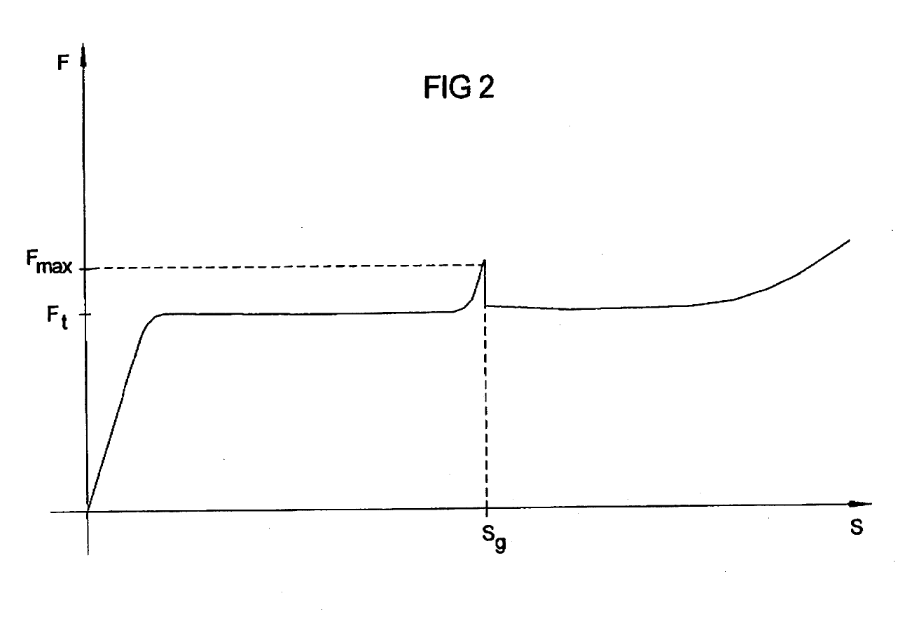

The belt restraining force F is represented in FIG. 2 (cf. range for S<Sg). It can be seen that the belt restraining force F has a value of approximately Fₜ, which is provided substantially only by the torsion bar 40.

During the torquing of the torsion bar 40, the cable 100 is first unwound within the receiving channel 120. After unwinding, the cable 100 is wound up again within the receiving channel 120 but in a winding direction opposite that of the original unwinding direction.

As soon as the cable 100 is completely wound up within the receiving channel 120, the cable 100 blocks any further extraction of the belt. This is represented in FIG. 2. It can be seen that in the event of a given belt extraction length S_{g}, the belt restraining force F increases abruptly.

In order to prevent injury to the vehicle's occupants, the cable 100 is to be provided with at least one breaking point 200, which limits the restraining force F applied by the cable 100 to a given maximum value Fₘₐₓ. If the restraining force F exceeds its maximum value Fₘₐₓ, the cable 100 breaks and the belt restraining force F falls back to the force level Fₜ provided by the torsion bar 40.

Thus, the function of the cable 100 rests in the fact that, when a predetermined belt extraction length S_{g} is reached, the belt restraining force F abruptly and instantly increases and, when the preset maximum belt restraining force Fₘₐₓ is exceeded, the safety belt is again released.

As FIG. 2 shows, the preset maximum belt restraining force Fₘₐₓ is greater than the belt restraining force Fₜ which is exerted by the first belt force limiting device in the form of the torsion bar 40.

In the embodiment according to FIGS. 1 and 2, the cable 100 is wound on and off in the channel 120. Alternatively, the cable 100 can also be wound on and off on the clutch 70 or directly on the torsion bar 40.

The priority application, German Application 10 2005 032 012.0, filed on Jul. 1, 2005, including the specification, drawings, claims, and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A belt winder for a vehicle safety belt comprising:
a belt spindle for winding the safety belt;
a belt force limiting device in communication with the belt spindle for limiting a belt restraining force exerted by the safety belt in case of an accident involving the vehicle;
a belt force increasing device for blocking further extraction of the safety belt upon reaching a predetermined belt extraction length, wherein the belt force increasing device is configured to automatically deactivate itself upon exceeding a preset maximum belt restraining force.

2. The belt winder according to claim 1, wherein the belt force increasing device is configured to deactivate itself by tearing or breaking upon exceeding the preset maximum belt restraining force.

3. The belt winder according to claim 1, wherein the belt force limiting device comprises a torsion bar.

4. The belt winder according to claim 3, further comprising a clutch configured to lock in the case of an accident, wherein the torsion bar is in communication at a first end with the belt spindle and at a second end with the clutch.

5. The belt winder according to claim 1, further comprising a clutch for rotating with the belt spindle in an accident-free case and configured to lock in the case of an accident.

6. The belt winder according to claim 1, wherein the belt force increasing device comprises a windable element.

7. The belt winder according to claim 6, wherein the windable element is a belt or a cable.

8. The belt winder according to claim 6, wherein the windable element is joined at a first end with the belt spindle and at a second end with a clutch configured to lock in the case of an accident.

9. The belt winder according to claim 8, wherein the windable element is arranged to wind on a winding device in case of any extraction of the belt while the clutch is closed, wherein the winding device is formed by an annular receiving channel that is concentric with a cylindrical space in the belt spindle.

10. The belt winder according to claim 9, wherein the belt force limiting device comprises a torsion bar disposed in the cylindrical space.

11. The belt winder according to claim 9, the windable element has a length such that the windable element increases the restraining power of the belt by winding completely on the winding device.

12. The belt winder according to claim 9, wherein the windable element is already at least partially wound on the winding device before an accident occurs.

13. The belt winder according to claim 9, wherein the windable element is wound on the winding device so such that when the belt is extracted with the clutch engaged, the windable element is at first unwound from the winding device, and only after a complete unwinding is the windable element wound again on the winding device in an opposite winding direction.

14. The belt winder according to claim 8, wherein the windable element is arranged to wind on the belt force limiting device in case of any extraction of the belt while the clutch is closed, wherein the belt force limiting device is formed by a torsion bar.

15. The belt winder according to claim 8, wherein the windable element is arranged to wind on the clutch in case of any extraction of the belt while the clutch is closed.

16. The belt winder according to claim 6, wherein the windable element has at least one breaking point which breaks upon exceeding the preset maximum belt restraining force.

17. The belt winder according to claim 1, wherein the preset maximum restraining force is greater than a belt restraining force exerted by the seat belt in the case of an accident before the predetermined belt extraction length is reached.

18. The belt winder according to claim 1, wherein the belt force increasing device is configured such that the belt force increasing device leaves the belt extraction at least approximately uninfluenced prior to reaching the predetermined belt extraction length in which a belt force limiting performance of the belt winder is at least predominantly determined by the belt force limiting device.

19. A vehicle seat belt winder comprising:
a spindle for winding the seat belt;
a force limiting device operatively connected to the spindle for limiting a restraining force exerted by the seat belt in case of an accident involving the vehicle;
a force increasing device for blocking further extraction of the seat belt when the seat belt has been extracted a predetermined belt length;
wherein the force increasing device is configured to automatically deactivate when the restraining force exceeds a predetermined value.

20. The belt winder of claim 19, wherein the force increasing device is configured so that the force increasing device does not influence the extraction of the seat belt when the seat belt has not yet reached the predetermined belt length.
